(19) United States
(12) Patent Application Publication
(10) Pub. No.: US 2024/0106308 A1
(43) Pub. Date: Mar. 28, 2024

(54) AXIAL FLUX MACHINE MANUFACTURE

(71) Applicant: YASA LIMITED, Oxfordshire (GB)

(72) Inventors: Tim WOOLMER, Oxfordshire (GB); Tom HILLMAN, Oxfordshire (GB)

(21) Appl. No.: 18/267,719

(22) PCT Filed: Dec. 7, 2021
(86) PCT No.: PCT/EP2021/084626

§ 371 Date: Jun. 15, 2023

(30) Foreign Application Priority Data
Dec. 18, 2020 (GB) 2020081.2
Jan. 8, 2021 (GB) 2100254.8

(51) Int. Cl. H02K 15/03; H02K 1/2798; H02K 21/24

(52) U.S. Cl. CPC H02K 15/03; H02K 1/2798; H02K 21/24

(57) ABSTRACT

A method of manufacturing permanent magnets for an axial flux permanent magnet machine. The axial flux permanent magnet machine comprises a stator with a set of coils disposed circumferentially at intervals about a machine axis, and a rotor bearing a set of permanent magnets disposed circumferentially at intervals about the machine axis. The rotor and stator are spaced apart to define a gap in which magnetic flux is generally in an axial direction. The method comprises, for each (permanent) magnet, mounting the magnet in a magnet fixture in a cutting position relative to a cutting machine configured to cut along an array of cutting lines, and moving the magnet and the array of cutting lines to simultaneously make an array of cuts across the magnet, each extending through a thickness of the magnet. The cutting machine may be a wire cutting machine.

### FIELD

This invention relates to methods of manufacturing an axial flux permanent magnet machine.

### BACKGROUND

As described herein an axial flux permanent magnet machine may be a motor or a generator. Typically such a machine typically has disc- or ring-shaped rotor and stator structures arranged about an axis. The stator comprises a set of coils each parallel to the axis and the rotor bears a set of permanent magnets and is mounted on a bearing so that it can rotate about the axis driven by fields from the stator coils.

FIG. 1a shows the general configuration of an example axial flux machine with a pair of rotors R1, R2 to either side of a stator S, although a simple structure could omit one of the rotors. There is an air gap G between the rotor(s) and stator, and in an axial flux machine the direction of flux through the air gap is substantially axial. Another configuration (not shown) extends this arrangement and has three stators and two rotors. FIG. 1b shows an example configuration with a single rotor (which may have permanent magnet faces exposed on both sides), and two stators one to either side of the rotor. Other variants are possible.

There are also various configurations of axial flux permanent magnet machines possible depending, for example, upon the arrangement of north and south poles on the rotor(s). FIG. 1b illustrates the basic configurations of a Torus NS machine, a Torus NN machine (which has a thicker yoke because the NN pole arrangement requires flux to flow through the thickness of the yoke), and a YASA (Yokeless and Segmented Armature) topology. The illustration of the YASA topology shows cross-sections through two coils, the cross-hatched area showing the windings around each coil. Here, dispensing with the stator yoke provides a substantial saving in weight and iron losses but there are drawbacks. One is loss of structural strength to the stator which the iron provided, even though there is potentially increased need for strength because the YASA topology is compact and can result in very large stresses. Another is loss of a route for heat to escape from stator coils, and coolant may therefore be circulated through the machine.

In such machines there is a need to minimise excess heat generation. More particularly as can be seen from FIG. 1b, for efficient operation, that is minimum loss in the high reluctance air gap, the gap between the rotor and stator should be as small as possible. However this is a problem because it inhibits heat loss from this region. This problem can be particularly acute in the YASA topology. There is also a general need for more compact designs and improved electrical efficiency. Background prior art is described in EP2760112A, JPH04169205A, and JP2003303728A.

### SUMMARY

One way to address the cooling problem is to reduce the generation of heat in the region between the rotor and stator. This can be done by reducing the eddy currents in each of the permanent magnets, which are typically made of an electrically conducting metal such as iron, or an iron-based material or alloy.

As the flux there is generally in an axial direction the eddy currents will tend to circulate in a plane perpendicular to the axial direction. Thus the eddy currents can be reduced by cutting non-conducting slots through the permanent magnet, i.e. through a thickness of the magnet in the axial direction. The slots should run so as to inhibit the circulation of eddy currents in the plane of the magnet facing the stator. However there are many permanent magnets in a motor and the further problem arises of finding a way quickly and efficiently to cut a set of slots which is effective for eddy current reduction.

In a first aspect there is therefore described a method of manufacturing permanent magnets, in particular for an axial flux permanent magnet machine.

The axial flux permanent magnet machine may comprise a stator comprising a set of coils, e.g. wound on respective stator teeth, and disposed circumferentially at intervals about a machine axis. In some topologies, e.g. a YASA topology, the stator teeth take the form of stator bars. The axial flux permanent magnet machine may further comprise a rotor mounted for rotation about the machine axis. The rotor bears a set of permanent magnets disposed circumferentially at intervals about the machine axis, e.g. on a ring-shaped back plate. Each permanent magnet may extend in a plane perpendicular to the machine axis and has a first face towards the stator and a second, opposite face, towards the back plate. The rotor and the stator are spaced apart along the machine axis to define a gap in which magnetic flux in the machine is generally in an axial direction.

The method may comprise, for each (permanent) magnet, mounting the magnet in a magnet fixture in a cutting position relative to a cutting machine configured to cut along an array of cutting lines. The method may further comprise moving the magnet and the array of cutting lines relative to one another to simultaneously make a corresponding array of cuts across the magnet. Each cut may extend through a thickness of the magnet from the first face to the second face.

Implementations of the method facilitate rapid manufacture of multiple permanent magnets for an axial flux permanent magnet machine. In addition this approach can facilitate the fabrication of permanent magnets with many fine, closely spaced cuts, which can be difficult to achieve with other techniques. This allows a closer approximation to a laminated structure than with some other approaches.

In implementations of the method permanent magnets for the machine are manufactured by cutting the magnets before they are magnetised, for ease of handling, although this is not essential. Thus the method may involve magnetising the permanent magnets after cutting; this may involve mounting the magnets on the rotor and then magnetising the magnets in-situ.

Thus references to a permanent magnet are to be understood as references to a magnet which, when incorporated into the axial flux permanent magnet machine, is a permanent magnet, but which may not necessarily be a permanent magnet at the time the cuts are made. As such, as used herein references to a permanent magnet may be or include references to a precursor to the permanent magnet.

In the methods described herein, and in the corresponding machines, the permanent magnets cut by the array of cutting lines are solid permanent magnets. Such solid magnets have typically been formed by a sintering process, starting with a so-called green body, which is physically soft and is formed from a powder, which is then fired so that it becomes solid and hard. Magnets which may be made in this way include those based on rare earth transition-metal inter-metallics including NdFeB and SmCo, and magnets based on hexagonal ferrites. Whilst it is much easier to cut the green body, the green body can change shape slightly during firing. For use in an axial flux permanent magnet machine as described it is advantageous to have an exact shape for the permanent magnets as this helps reduce tolerances, which in turn can make the machine more effective and more efficient. Thus in the described method it is solid permanent magnets that are cut by the array of cutting lines, rather than a green body. As noted, in implementations of the described method the solid permanent magnets are still unmagnetised when cut.

Lines of the array of cutting lines may each extend in a direction which defines a line axis. In implementations of the method mounting the permanent magnet in the magnet fixture may comprise mounting the permanent magnet such that the line axis is perpendicular to planes defined by the first and second faces. For example the permanent magnets may each comprise a shaped slab of magnetic material, and this slab may be mounted vertically with the cutting lines descending from above. The permanent magnets may be made from iron, or an iron-based material or alloy, and/or may comprise other magnetic materials such as neodymium.

As previously mentioned, the permanent magnets may fit around a ring defined by the rotor, specifically the back plate of the rotor. In implementations each permanent magnet has a shape which fits within a sector of the ring—though the fit may not be exact; and in some implementations the magnets may differ slightly in shape from one another. Each permanent magnet may have a pair of lateral edges defined by a radial direction (i.e. radial from the machine axis), and may have inner and outer edges which fit within inner and outer edges of the ring. Thus a permanent magnet may in some instances be described as a slab of magnetic material having the shape of a sector of a ring, approximately a truncated triangle.

The cuts may maintain a constant distance from one another along the length of each cut. In some implementations the cutting lines are the same distance from one another, i.e. they are equally spaced. In some other implementations the cutting lines have different distances from one another. For example the cutting lines may be arranged so that there is a greater density of cuts (per unit length) towards the outer edge than towards to the inner edge. That is the cuts may be more closely spaced as radial distance from the machine axis increases. This is because eddy current losses can be greater at greater radial distances from the machine axis, and this approach can better mitigate such losses.

In some implementations moving the permanent magnet relative to the array of cutting lines comprises translating at least one of the permanent magnet and the array of cutting lines towards the other along a first direction. This may be the only degree of freedom of movement.

In some implementations the method may comprise making a single array of e.g. straight cuts from one of the lateral edges and from part of the outer edge. The cuts may extend almost to the other lateral edge, leaving a strip of permanent magnet along the other lateral edge to connect elements divided by the cuts at one end, for structural integrity. Starting the cuts from both one of the lateral edges and part of the outer edge helps to divide more of the area of a permanent magnet into separate elements without leaving a large undivided region, thus facilitating improved eddy current reduction.

In the methods described herein the elements divided by the cuts are akin to laminations, and may be referred to as such.

In some implementations the method may comprise making a first array of e.g. straight cuts into the permanent magnet from one of the lateral edges and making a second array of e.g. straight cuts into the permanent magnet from the other lateral edge, such that cuts of the first and second arrays of cuts do not meet one another. The cuts so formed may define a “fishbone” pattern, that is the cuts may be aligned so that they would meet if extended. In this case a central strip of the permanent magnet may connect the elements formed by the cuts. Or the cuts may interlace one another e.g. so that the elements divided by the cuts define a serpentine pattern.

In some implementations moving the permanent magnet relative to the array of cutting lines includes translating at least one of the permanent magnet and the array of cutting lines along a second direction orthogonal to both the first direction and to the line axis. Such a method involves two degrees of freedom. Thus the method may translate permanent magnet and the array of cutting lines relative to one another in two directions at the same time, to form curved cuts.

Thus some implementations of this method comprise making a single array of curved cuts from one of the lateral edges. In a direction perpendicular to the line axis the cuts may maintain a constant distance from one another along the length of each cut because the line spacing may remain constant. However, as explained in more detail later, a distance between adjacent cuts measured in a radial direction can vary along the length of a cut. Where the arcuate lamina formed by the method are very thin this may limit how thin the divided elements (laminations) can be.

As before the cuts may extend almost to the other lateral edge, leaving a strip of permanent magnet to connect the divided elements at one end for structural integrity. In such a method the cuts may each have the same radius of curvature. However the curves defined by the cuts, which may each define an arc of a circle, may have different origins i.e. the circles defining the arcs may have different centres. An advantage of making curved cuts is that, for the shapes of permanent magnets described above, i.e. those found in an axial flux permanent magnet machine, more of the area may be divided by the cuts thus facilitating better eddy current reduction.

In some implementations moving the permanent magnet relative to the array of cutting lines comprises rotating at least one of the permanent magnet and the array of cutting lines towards the other about a cutting axis. The cutting axis may be parallel to the line axis.

The method may then comprise making a first array of curved cuts from one of the lateral edges. Again the curved cuts of the first array of curved cuts may maintain a constant distance from one another along the length of each cut. However if the line spacing remains constant during the cutting a distance between adjacent cuts measured in a radial direction is constant along the length of a cut. As before the cuts may extend almost to the other lateral edge, leaving a strip of permanent magnet to connect the divided elements at one end for structural integrity. In such a method the cuts each define an arc of a circle and the circles defining the arcs have the same centre (a common origin). This approach provides the previously described advantage of curved cuts, but with a potentially simpler mechanical arrangement, and potentially closer cuts.

In some implementations the method includes making a second array of curved cuts from the other of the lateral edges. Like those of the first array of curved cuts, the curved cuts of the second array of curved cuts may have a constant radial distance from one another along the length of each cut.

The cuts of the first and second arrays of curved cuts may be made so that they do not meet one another. For example, as previously described for straight cuts, the cuts may define a “fishbone” pattern, aligned so that they would meet if extended. Or the cuts of the first and second arrays of curved cuts may be interlaced so that cuts from one lateral edge extend between cuts from the other lateral edge, e.g. so that the elements (laminations) divided by the cuts define a serpentine pattern. This can be facilitated by the described rotational movement.

Some implementations of the method include filling the cuts with a non-magnetic material such as epoxy, for improved structural stability. However this is not essential and structural stability may be provided by mounting the permanent magnets on the rotor, e.g. by attaching the permanent magnets to the rotor back plate.

In some implementations cuts may be made in multiple permanent magnets simultaneously. Thus the method may involve mounting multiple permanent magnets in the magnet fixture such that the array of lines spans the multiple permanent magnets, and moving the multiple permanent magnets and the array of cutting lines relative to one another to simultaneously make an array of cuts across each of the permanent magnets.

In some implementations the cutting machine is a wire cutting machine with an array of cutting wires, and the cutting lines are defined by the cutting wires of the machine.

For example in some implementations the wire cutting machine is a multi-wire sawing machine. In such a machine the wires may be thin and the cuts may be correspondingly narrow. This facilitates making many fine, closely spaced cuts, and hence improved eddy current loss reduction.

In some other implementations the wire cutting machine is an EDM (electrical discharge machining) machine which uses spark erosion to make the cuts.

In some implementations the cutting machine is a laser cutting machine and the cutting lines are defined by the laser beams.

In some implementations the cutting machine is a water jet cutting machine and the cutting lines are defined by the water jets. The water jets may, but need not, include abrasive.

There is also provided a method of manufacturing an axial flux permanent magnet machine, by manufacturing permanent magnets for the machine as described above, then using the permanent magnets to make the machine.

In another aspect there is described an axial flux permanent magnet machine comprising a stator comprising a set of coils e.g. wound on respective stator bars and disposed circumferentially at intervals about a machine axis, and a rotor mounted for rotation about the machine axis. The rotor has a set of permanent magnets disposed circumferentially at intervals about the machine axis. Each permanent magnet may extend in a plane perpendicular to the machine axis and may have a first face towards the stator and a second, opposite face. The rotor and the stator are spaced apart along the machine axis to define a gap in which magnetic flux in the machine is generally in an axial direction. The permanent magnets may fit around a ring defined by the rotor. Each permanent magnet may have a shape which fits within a sector of the ring, with a pair of lateral edges defined by a radial direction and inner and outer edges which fit within inner and outer edges of the ring. Each of the permanent magnets has an array of cuts. Each cut may extend through a thickness of the permanent magnet from the first face to the second face.

In one implementation a single array of e.g. straight cuts extends inwards from one of the lateral edges and from part of the outer edge, in particular leaving a bridge along the other lateral edge to connect the cut elements.

In one implementation a first array of e.g. straight cuts extends inwards from one of the lateral edges and a second array of e.g. straight extends inwards from the other lateral edge, such that cuts of the first and second arrays of cuts do not meet one another. The cuts of the first and second arrays of cuts may be aligned so that they would meet if extended e.g. so that each cut of one array defines a line and a corresponding cut of the other array lies on the same line. Or the cuts of the first and second arrays of cuts may be interlaced.

In one implementation a single array of curved cuts extends inwards from one of the lateral edges. However, as described above, in some approaches a distance between adjacent cuts measured in a radial direction varies along the length of a cut, whereas in other approaches the curved cuts may maintain a constant distance from one another along the length of each cut. In either approach a bridge may be left along the other lateral edge to connect the cut elements.

In one implementation a first array of curved cuts extends inwards from one of the lateral edges and a second array of curved cuts extends inwards from the other of the lateral edges. Depending on how they are made the curved cuts of each array of curved cuts may maintain a constant distance from one another along the length of each cut; or the distance may vary. The cuts of the first and second arrays of curved cuts do not meet one another. As previously described the cuts may define a “fishbone” arrangement i.e. where the cuts would meet one another if extended, or they may define an interlaced arrangement i.e. where the cuts from one lateral edge extend between the cuts from the other lateral edge.

The axial flux permanent magnet machine may be a motor or a generator. In implementations it has a YASA (Yokeless and Segmented Armature) topology.

### BRIEF DESCRIPTION OF THE DRAWINGS

These and other aspects of the invention will now be further described, by way of example only, with reference to the accompanying figures in which:

FIGS. 1a to 1c show, respectively, a general configuration of a two-rotor one-stator axial flux machine, a general configuration of a two-stator one-rotor axial flux machine, and example topologies for axial flux permanent magnet machines.

FIGS. 2a and 2b show a schematic side view of a yokeless and segmented armature (YASA) machine, and a perspective view of the machine of FIG. 2a.

FIGS. 3a to 3e show a side view of a first example of apparatus for manufacturing permanent magnets, and examples of manufactured magnets.

FIGS. 4a and 4b show a side view of a second example of apparatus for manufacturing permanent magnets, and an example of a magnet manufactured using the apparatus.

FIGS. 5a-5d show a side view of a third example of apparatus for manufacturing permanent magnets, examples of magnets manufactured using the apparatus, and an example geometry for the apparatus.

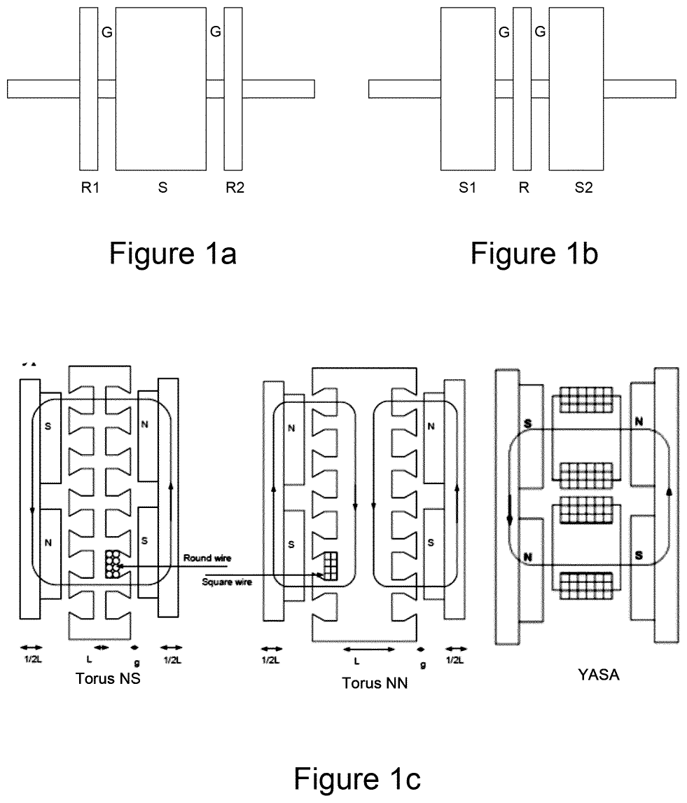

In the Figures like elements are indicated by like reference numerals.

### DETAILED DESCRIPTION OF PREFERRED EMBODIMENTS

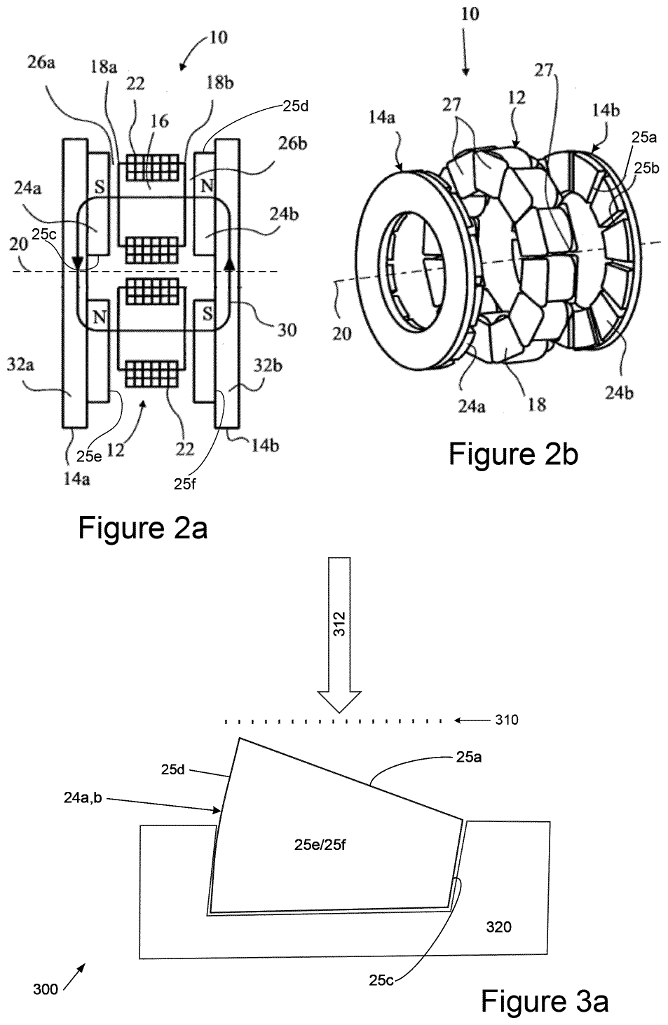

FIGS. 2a and 2b, which are taken from WO2012/022974, show schematic illustrations of an example yokeless and segmented armature (YASA) machine 10. The machine 10 may function either as a motor or as a generator.

The machine 10 comprises a stator 12 and, in this example, two rotors 14a,b. The stator 12 comprises a collection of separate stator bars 16 spaced circumferentially about a machine axis 20, which also defines an axis of the rotors 14a,b. Each bar 16 carries a stator coil 22, and has an axis which is typically disposed parallel to the rotation axis 20. Each end 18a,b of the stator bar is provided with a shoe 27, which helps to confine coils of the stator coil 22 and may also spread the magnetic field generated by the stator coil. The stator coil 22 may be formed from square or rectangular section insulated wire so that a high fill factor can be achieved. In a motor the stator coils 22 are connected to an electrical circuit (not shown) that energizes the coils so that poles of the magnetic fields generated by currents flowing in the stator coils are opposite in adjacent stator coils 22.

The two rotors 14a,b carry permanent magnets 24a,b that face one another with the stator coil 22 between. The permanent magnets 24a,b have lateral edges 25a,b, and inner and outer edges, respectively 25c and 25d. Each permanent magnet extends in a plane perpendicular to the machine axis 20 and has a first face 25e towards the stator and a second, opposite face 25f. When the stator bars are inclined (not as shown) the magnets are likewise inclined.

Gaps 26a,b are present between respective shoe and magnet pairs 17/24a, 27/24b; these may be air gaps or partially occupied by a coolant-containing chamber around the stator. In an example motor the stator coils 22 are energized so that their polarity alternates to cause coils at different times to align with different magnet pairs, resulting in torque being applied between the rotor and the stator.

The rotors 14a,b are generally connected together, for example by a shaft (not shown), and rotate together about the machine axis 20 relative to the stator 12. In the illustrated example a magnetic circuit 30 is formed by two adjacent stator bars 16, two magnet pairs 24a,b, and two back plates 32a,b, one for each rotor, linking the flux between the backs of each magnet pair 24a,b facing away from the respective coils 22. The back plates 32a,b may be referred to as back irons and comprise a magnetic material, typically a ferromagnetic material, for example, but not necessarily, iron or steel. This magnetic material is not required to be a permanent magnet. The stator coils 16 are enclosed within a chamber (not shown) for the stator, which may be plastic and which may be supplied with a coolant. The rotors may be outside this chamber but within a protective, e.g. metal, housing for the machine.

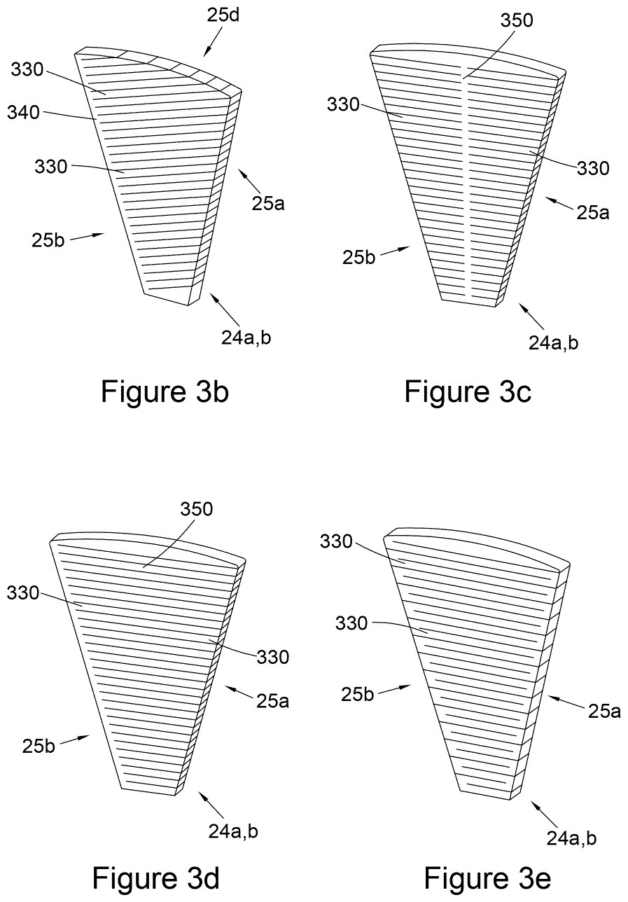

FIG. 3a shows, schematically, a side view of a first example of apparatus 300 for manufacturing permanent magnets. The apparatus comprises a cutting machine with an array 310 of cutting lines; there may be e.g. around 20-100 cutting lines spaced at e.g. 1-5 mm.

In some implementations the cutting machine is a wire cutting machine, in particular a multi-wire sawing machine e.g. of the type used to slice silicon wafers. Such a machine may use the wires to transport an abrasive slurry to the cutting zone; the slurry may comprise a suspension of abrasive particles in a coolant fluid fed onto the moving wires e.g. by a set of nozzles. Alternatively a multi-wire sawing machine may have diamond-coated wires. In such machines the wires may be thin e.g. less than 200 μm diameter, and the cuts may be correspondingly narrow.

In some other implementations the cutting machine is a laser cutting machine or a water jet cutting machine. Then the array of cutting lines may be defined by, respectively, the laser beams or water jets of the cutting machine. Such cutting technologies can have speed or cost advantages over wire-based cutting.

One of the permanent magnets 24a,b is held in a magnet fixture 320, with one of the lateral edges upwards, as illustrated lateral edge 25a. The magnet may be clamped in position e.g. by its inner and outer edges 25c, 25d, or fastened along one edge e.g. where a bridge is present along the edge as described later.

An axis of the lines (into the page) is perpendicular to planes defined by the first and second faces 25e/25f. The cutting lines e.g. wires are moved down in a first direction indicated by arrow 312 and make an array of cuts across the permanent magnet through a thickness of the permanent magnet between faces 25e and 25f.

With the permanent magnet 24a,b held as illustrated the array of cutting lines makes cuts starting from lateral edge 25a and outer edge 25d. This results in a permanent magnet with cuts as shown in FIG. 3b. The cuts extend almost to the opposite lateral edge 25b, dividing the permanent magnet into elements 330 which are similar to laminations. A thin strip of material 340, e.g. 1-2 mm wide, may be left uncut adjacent to lateral edge 25b to connect (bridge) elements 330.

In another method the permanent magnet may be rotated slightly anticlockwise relative to the position illustrated, and the array of cutting lines may be used to make two sets of cuts, one starting from each of lateral edges 25a and 25b. This results in the “fishbone” pattern of cuts shown in FIG. 3c. In this case an uncut central strip 350 (or bridge) may connect the cut elements.

In another method, a single set of straight cuts may be made inwards from just one of the lateral edges, as shown in FIG. 3d. In this example the cuts are made from edge 25a and a thin strip of material is left uncut adjacent to lateral edge 25b to connect or bridge the cut elements 330.

In another method the array of lines may be used to make two sets of cuts, one starting from each of lateral edges 25a and 25b, where the cuts are interlaced as shown in FIG. 3e. In this case a greater spacing of cuts (lines e.g. wires) may be used. An uncut strip is unnecessary as the elements divided by the cuts remain connected to define a serpentine pattern as shown.

The interlaced cut arrangement shown in FIG. 3e requires translation of the permanent magnet relative to the cutting lines, e.g. wires, perpendicular to the line axis (and to direction 312), horizontally in FIG. 3a. This may be achieved with two different magnet fixtures 320, or with a fixture that allows the permanent magnet 24a,b to be fixed in two different positions, or using apparatus which allows translation in a second direction as described below.

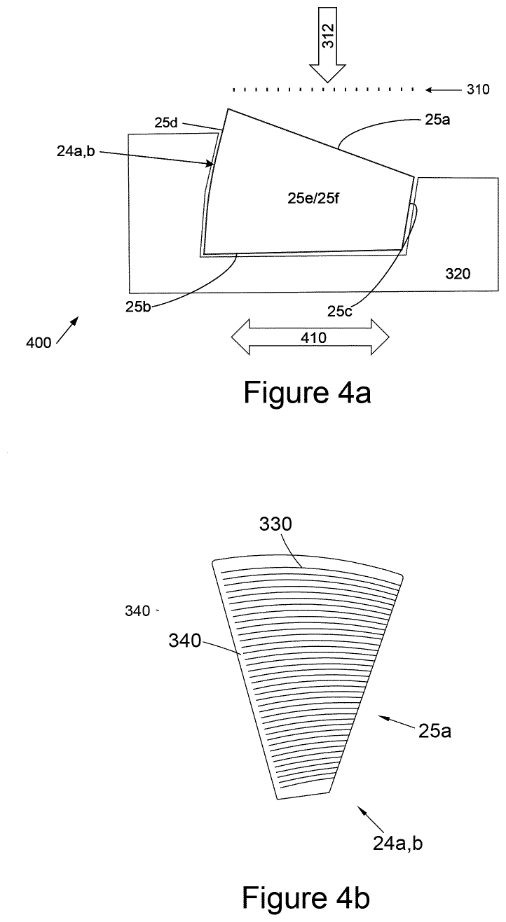

FIG. 4a shows, schematically, a side view of a second example of apparatus 400, for a second method of manufacturing permanent magnets. In this second method the magnet fixture 320 is translated in a second direction 410 (horizontally), orthogonal to the first direction 312 and to the line axis. The magnet fixture 320 is configured so that it may be moved in this second direction 410, either manually or automatically.

If the magnet fixture 320 is arranged to move between two fixed positions along the second direction whilst cuts are made into each of respective lateral edges 25a and 25b, the interlaced cut arrangement of FIG. 3d results. If the magnet fixture 320 is arranged to move in the second direction (horizontally) at the same time as the cutting lines, e.g. wires, are moved in the first direction 312 (down), curved cuts are made as shown in FIG. 4b. Then, as previously, a thin strip of bridge material 340 may be left uncut to connect elements 330.

When the apparatus of FIG. 4a is used to make curved cuts, whilst the curves may each define an arc of a circle, these arcs have different origins i.e. the circles defining the arcs have different centres. As a result, even though the line spacing and hence cut spacing is constant, a distance between adjacent cuts measured in a radial direction varies along the length of a cut: In FIG. 4a, as the array of cutting lines descends the leftmost line begins to cut, but the permanent magnet has moved horizontally left (in the Figure) before the next cutting line, e.g. wire, begins to cut. In principle this could limit the thickness of the elements (laminations) if there is a minimum desired thickness at the leading lateral edge, here lateral edge 25a. In practice there is a minimum thickness of cut and thin strip (if required), which is a function of the structural integrity of the magnet material being cut.

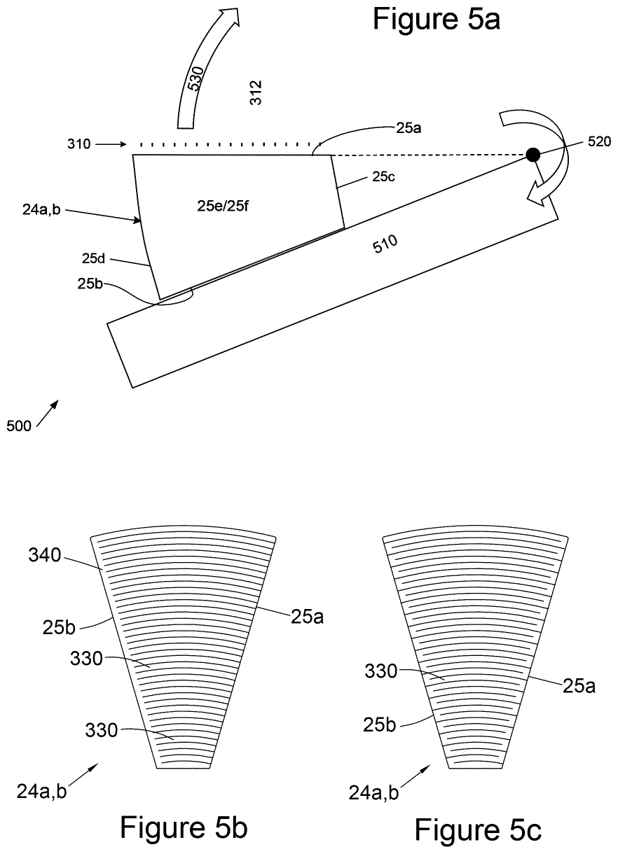

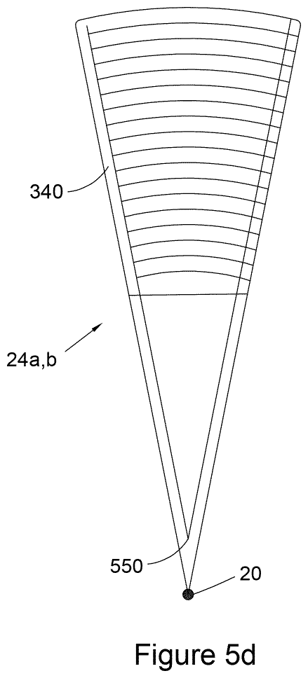

FIG. 5a shows, schematically, a side view of a third example of apparatus 500 for a further method of manufacturing permanent magnets in which a magnet fixture 510 is rotated about a cutting axis 520, parallel to the line axis. In the apparatus of FIG. 5a the array 310 of cutting lines may have a fixed position and the permanent magnet 24a,b may move (up) through the array, as shown by arrow 530. The magnet fixture 510 may mount the permanent magnet 24a,b on one of its lateral edges 25b, as shown. For example the permanent magnet may be glued in place, or clamped by its inner and outer edges 25c,d.

Apparatus 500 may be used to making an array of curved cuts from one of the lateral edges, e.g. lateral edge 25a, as shown in FIG. 5b. However, unlike the cuts of apparatus 400, these curved cuts have a constant radial distance from one another along the length of each cut. The cuts define arcs with a common origin 550, that is the circles they define have a common centre but, as illustrated in FIG. 5d, the arcs have different radii of curvature.

The common origin 550 may, but need not be, coincident with a location defined by the machine axis 20. For example, as shown in FIG. 5d, the common origin may be displaced slightly away from the machine axis 20. Depending on the shape of the permanent magnet, this can help maximise an area of the permanent magnets provided with cuts (i.e. minimise an uncut region), and hence can help reduce eddy current losses. In some implementations an outermost cut is approximately parallel to outer edge 25d. Again a thin strip of material 340 may be left uncut to connect the cut elements.

Apparatus 500 may also be used to make two arrays of curved cuts one from each of the lateral edges 25a,b. These may be interlaced as shown in FIG. 5c, to define a serpentine pattern as previously described for straight cuts. This may be done by translating the cutting axis 520 in a direction perpendicular to the cutting axis (horizontally in the figure), or by similarly translating the array 310 of cutting lines

After the cuts have been made the gaps may be filled with epoxy or similar to make the permanent magnets physically easier to handle and less fragile, though this is not essential.

For efficiency, the above described apparatus 300, 400, 500 may mount and cut multiple permanent magnets simultaneously. For example 10-50 magnets may be cut simultaneously.

The shape of each permanent magnet may depend, for example, on a diameter of the machine and the number of permanent magnets. When there are many magnets and/or where the diameter is large an individual permanent magnet may have a shape which is close to a rectangle or square. In such a machine a large part of the area of the magnet may be cut into “laminations” by making cuts from the inner or outer edges of the magnet also or instead of from one or both of the lateral edges.

Thus implementations of the method, and a corresponding machine, contemplate techniques like those described above, with one or two translational degrees of freedom or with a rotational degree of freedom, but making one or more arrays of cuts from the inner and/or outer edge of a permanent magnet instead of from one of the lateral edges. The cuts may be otherwise similar to those previously described.

No doubt many other effective alternatives will occur to the skilled person. It will be understood that the invention is not limited to the described embodiments and encompasses modifications and equivalents apparent to those skilled in the art lying within the scope of the claims appended hereto.

1. A method of manufacturing permanent magnets for an axial flux permanent magnet machine, the axial flux permanent magnet machine comprising:
a stator comprising a set of coils disposed circumferentially at intervals about a machine axis, and
a rotor mounted for rotation about the machine axis, the rotor bearing a set of permanent magnets disposed circumferentially at intervals about the machine axis,
each permanent magnet extending in a plane perpendicular to the machine axis and having a first face towards the stator and a second, opposite face, and
wherein the rotor and the stator are spaced apart along the machine axis to define a gap in which magnetic flux in the machine is generally in an axial direction;
the method comprising, for each permanent magnet:
mounting the permanent magnet in a magnet fixture in a cutting position relative to a cutting machine configured to cut along an array of cutting lines; and
moving the permanent magnet and the array of cutting lines relative to one another to simultaneously make an array of cuts across the permanent magnet, wherein each cut extends through a thickness of the permanent magnet from the first face to the second face.

2. The method of claim 1, wherein lines of the array of cutting lines each extend in the direction of a line axis, and wherein mounting the permanent magnet in the magnet fixture comprises mounting the permanent magnet such that the line axis is perpendicular to planes defined by the first and second faces.

3. The method of claim 1, wherein moving the permanent magnet relative to the array of cutting lines comprises translating at least one of the permanent magnet and the array of cutting lines towards the other along a first direction.

4. The method of claim 3, wherein the permanent magnets fit around a ring defined by the rotor, each permanent magnet having a shape which fits within a sector of the ring, with a pair of lateral edges defined by a radial direction and inner and outer edges which fit within inner and outer edges of the ring, the method comprising making a single array of cuts from one of the lateral edges and from part of the outer edge.

5. The method of claim 3, wherein the permanent magnets fit around a ring defined by the rotor, each permanent magnet having a shape which fits within a sector of the ring, with a pair of lateral edges defined by a radial direction and inner and outer edges which fit within inner and outer edges of the ring, the method comprising making a first array of cuts into the permanent magnet from one of the lateral edges and making a second array of cuts into the permanent magnet from the other lateral edge, such that cuts of the first and second arrays of cuts do not meet one another.

6. The method of claim 3, wherein lines of the array of lines each extend in the direction of a line axis, and wherein moving the permanent magnet relative to the array of cutting lines further comprises translating at least one of the permanent magnet and the array of cutting lines along a second direction orthogonal to both the first direction and to the line axis at the same time as translating at least one of the permanent magnet and the array of cutting lines towards the other along the first direction.

7. The method of claim 6, wherein the permanent magnets fit around a ring defined by the rotor, each permanent magnet having a shape which fits within a sector of the ring, with a pair of lateral edges defined by a radial direction and inner and outer edges which fit within inner and outer edges of the ring, the method comprising making a single array of curved cuts from one of the lateral edges.

8. The method of claim 1, wherein moving the permanent magnet relative to the array of cutting lines comprises rotating at least one of the permanent magnet and the array of cutting lines towards the other about a cutting axis.

9. The method of claim 8, wherein the permanent magnets fit around a ring defined by the rotor, each permanent magnet having a shape which fits within a sector of the ring, with a pair of lateral edges defined by a radial direction and inner and outer edges which fit within inner and outer edges of the ring, the method comprising making a first array of curved cuts from one of the lateral edges, wherein the curved cuts of the first array of curved cuts have a constant radial distance from one another along the length of each cut.

10. The method of claim 9, comprising making a second array of curved cuts from the other of the lateral edges, wherein the curved cuts of the second array of curved cuts have a constant radial distance from one another along the length of each cut, and such that cuts of the first and second arrays of curved cuts do not meet one another.

11. The method of claim 10, wherein cuts of the first and second arrays of curved cuts are interlaced.

12. The method of claim 1, further comprising filling the cuts with a non-magnetic material.

13. The method of claim 1, further comprising mounting the permanent magnets on the rotor.

14. The method of claim 1, comprising mounting multiple permanent magnets in the magnet fixture such that the array of cutting lines spans the multiple permanent magnets, and moving the multiple permanent magnets and the array of cutting lines relative to one another to simultaneously make an array of cuts across each of the multiple permanent magnets.

15. The method of claim 1, wherein the cutting machine is a wire cutting machine, and wherein the array of cutting lines is defined by wires of the wire cutting machine.

16. (canceled)

17. The method of claim 1, further comprising: manufacturing the axial flux permanent magnet machine using the permanent magnets.

18. An axial flux permanent magnet machine comprising:
a stator comprising a set of coils disposed circumferentially at intervals about a machine axis, and
a rotor mounted for rotation about the machine axis, the rotor bearing a set of permanent magnets disposed circumferentially at intervals about the machine axis,
each permanent magnet extending in a plane perpendicular to the machine axis and having a first face towards the stator and a second, opposite face, and
wherein the rotor and the stator are spaced apart along the machine axis to define a gap in which magnetic flux in the machine is generally in an axial direction;
wherein the permanent magnets fit around a ring defined by the rotor, each permanent magnet having a shape which fits within a sector of the ring, with a pair of lateral edges defined by a radial direction and inner and outer edges which fit within inner and outer edges of the ring;
wherein each of the permanent magnets has an array of cuts, wherein each cut extends through a thickness of the permanent magnet from the first face to the second face; and wherein
i) a single array of cuts extends inwards from one of the lateral edges and from part of the outer edge; or
ii) a first array of cuts extends inwards from one of the lateral edges and a second array of extends inwards from the other lateral edge, such that cuts of the first and second arrays of cuts do not meet one another; or
iii) a single array of curved cuts extends inwards from one of the lateral edges; or
iv) a first array of curved cuts extends inwards from one of the lateral edges, a second array of curved cuts extends inwards from the other of the lateral edges, and cuts of the first and second arrays of curved cuts do not meet one another.

19. The axial flux permanent magnet machine of claim 18, wherein the cuts extend inwards from one of the lateral edges and a strip of uncut material is left along the other lateral edge to connect cut elements of the permanent magnet.

20. The axial flux permanent magnet machine of claim 18, wherein the cuts are curved cuts, and wherein a distance between adjacent cuts measured in a radial direction varies along the length of a cut.

21. The axial flux permanent magnet machine of claim 18, wherein the axial flux permanent magnet machine has a YASA (Yokeless and Segmented Armature) topology.
